(19) United States
(12) Patent Application Publication
(10) Pub. No.: US 2006/0081133 A1
(43) Pub. Date: Apr. 20, 2006

(54) Cheese processing system

(75) Inventor: Brian Schmitz, New Holstein, WI (US)

Correspondence Address: FOLEY & LARDNER LLP, 777 EAST WISCONSIN AVENUE, SUITE 3800, MILWAUKEE, WI, 53202-5308, US

(73) Assignee: Stoelting, LLC

(21) Appl. No.: 10/967,377

(22) Filed: Oct. 18, 2004

(51) Int. Cl. A23C 1/00

(52) U.S. Cl. 99/452

(57) ABSTRACT

A cheese processing system includes a vat and a knife extending into the vat. A drive mechanism is configured to move the knife in a horizontal direction through the vat. The knife continuously reciprocates in a vertical direction as the knife moves in the horizontal direction through the vat.

### FIELD OF THE INVENTION

The present invention relates to a system for processing cheese. In particular, the present invention relates to a cheese processing system having an improved curd knife and cutting process for cutting the coagulum in a vat into cubes.

### BACKGROUND OF THE INVENTION

Traditionally, much of the processing of various cheese products, such as cottage cheese, has been carried out in processing vats, the vats normally being rectangular in shape. During the cheese making process, a coagulum is formed within the vat. For various reasons, including improving the efficiency of the cheese making process and facilitating the drainage of whey, it is desirable to cut the coagulum into cubes at various times during processing.

A common method used to cut the coagulum into cubes involves a two step process. During the first step, a first wire strung knife is mounted to a carriage and moved along a track spanning the length of the vat. The wires are typically strung in a grid on the knife. The knife is passed through the vat and the coagulum, thereby slicing the coagulum into columns having cross-sectional dimensions essentially equal to the grid pattern of the cutting wires. During the second step, a second wire strung knife having vertically strung wires is passed widthwise (i.e., perpendicular to the first cut) through the vat and the coagulum to cut the columns into cubes. The second step of the cutting process normally involves manually making multiple transverse cuts across the width of the vat.

One challenge associated with the above-described method of cutting the coagulum is that it requires multiple cutting steps. Each added step requires the expenditure of additional time, labor, and therefore costs in processing the cheese. Additionally, the second step, often being manually performed, is labor intensive. It would be desirable to minimize the number of steps and amount of labor involved in cutting the coagulum.

A further challenge associated with the traditional method of cutting the coagulum is the production of fines, which break off from the cubes or coagulum during the cutting process. The amount of fines produced increases with the number of cutting steps involved (i.e., a two-step process will likely produce a higher concentration of fines than a one-step process). Also, the way in which each cut is made may affect the production of fines (e.g., sudden changes in the speed or direction of the cutting element may create more fines). Because the ultimate yield of the cheese making process decreases as the amount of fines increases, it is desirable to minimize the production of fines during the cutting process.

One approach to minimizing the problems associated with cutting the coagulum involves a method of making a single pass through the vat with a wire strung knife. According to one embodiment of this method, a knife has a set of horizontal cutting wires and a set of vertical cutting wires arranged in a grid-type fashion. The knife is mounted to a carriage above the vat. As the carriage moves the knife along the length of the vat at a constant speed, the knife is moved back and forth at regular intervals in a direction perpendicular to the direction of travel of the carriage.

A disadvantage of the above-described single pass approach is that the high rate of speed and acceleration required to periodically move the knife in a direction perpendicular to the direction of travel of the carriage tends to increase the production of fines. Rapid movement of the cutting element creates more fines because the cutting wires tear the curd rather than making a smooth cut. During the conventional single pass cutting process, the carriage travels at a constant speed along the length of the vat, moving the knife at the same speed. In order to form cubes, the knife must be periodically moved perpendicular to its direction of travel at a high speed and using a high rate of acceleration in order to maintain an orthogonal relationship between the cutting due to the reciprocation of the frame and the cutting due to the travel of the carriage. As a result of using such high speeds in cutting the coagulum, more fines are created.

Accordingly, there is a need for a system of cutting the coagulum formed during the cheese making process that minimizes the labor required and accomplishes the cutting in a single step. Further, there is a need to accomplish the single-step cut in such a way that the production of fines is minimized, thereby maximizing the yield of the process.

It would be desirable to provide a system and/or method that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY OF THE INVENTION

The invention relates to a cheese processing system having a vat and a knife extending into the vat. A drive mechanism is configured to move the knife in a first direction through the vat. The knife continuously reciprocates in a second direction orthogonal to the first direction as the knife moves in the first direction through the vat.

The invention further relates to a method for processing cheese. The method includes the steps of providing a vat and a knife extending into the vat, wherein the knife has a plurality of cutting wires. The method further includes the steps of moving the knife through the vat in a first direction and continuously reciprocating the knife in a second direction orthogonal to the first direction as the knife moves through the vat in the first direction.

The invention further relates to a knife for cutting a coagulum having a frame with at least one straight portion, and a plurality of first cutting wires mounted to the frame that are parallel to each other and the straight portion. A plurality of second cutting wires are mounted to the frame and are parallel to each other and the straight portion. A first plane defined by the plurality of first cutting wires is parallel to and spaced apart from a second plane defined by the plurality of second cutting wires.

The invention is capable of other embodiments and of being practiced or being carried out in various ways. Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is a perspective view of a cheese processing vat;

FIG. 2 is an elevation view of a curd knife;

FIG. 3 is a sectional view of the curd knife of FIG. 2 taken generally along line 3-3;

FIG. 4 is a fragmentary sectional view of the curd knife of FIG. 3 taken generally along line 4-4;

FIG. 5 is a fragmentary elevation view of the curd knife of FIG. 2 taken at the location identified by line 5-5;

FIG. 6 is a fragmentary perspective view of a curd knife;

FIG. 7 is a fragmentary sectional view indicating the motion of the curd knife of FIG. 2 taken generally along line 7-7;

FIG. 8 is a fragmentary sectional view indicating the motion of the curd knife of FIG. 2 taken generally along line 8-8;

FIG. 9 is a perspective view of a section of coagulum;

FIG. 10 is a perspective view of a section of coagulum after having been cut by horizontal cutting wires; and

FIG. 11 is a perspective view of a section of coagulum after having been cut by vertical cutting wires.

### DETAILED DESCRIPTION OF THE PREFERRED EMBODIMENTS

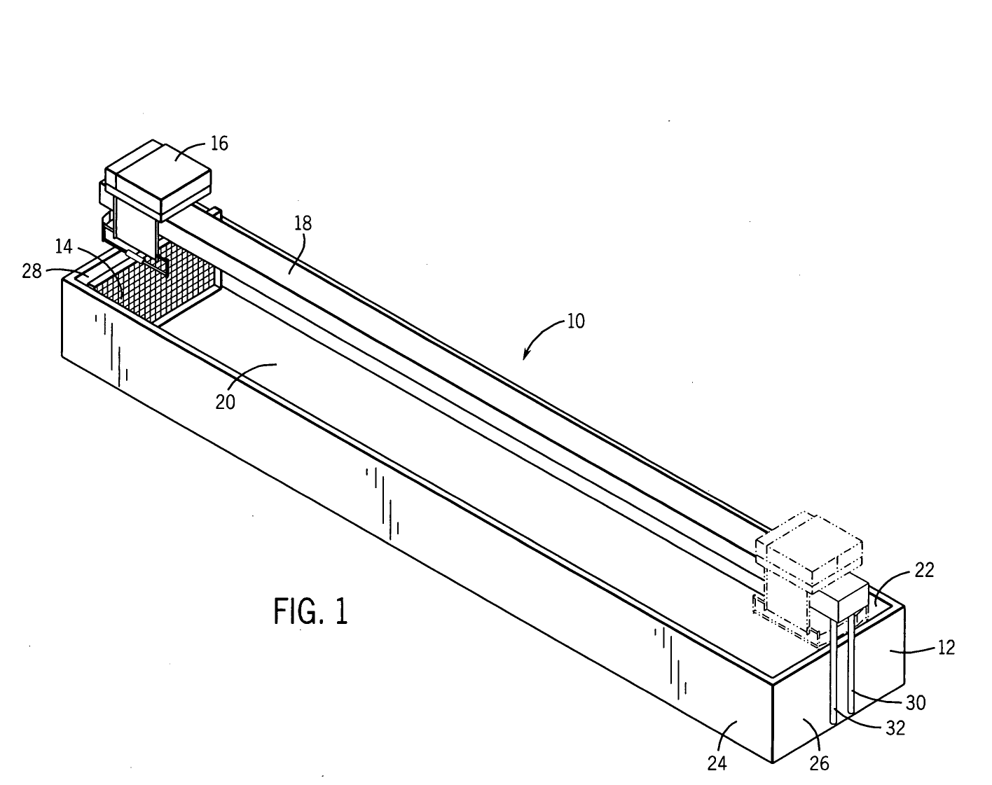

Referring to FIG. 1, according to an exemplary embodiment of the present invention, a cheese processing system 10 has a processing vat or storage tank 12, a knife assembly, shown as knife 14, and a drive mechanism, shown as carriage 16 and track 18. Knife 14 may be removably coupled to carriage 16 so that knife 14 can be attached to or detached from carriage 16 at various points during a cheese making process. Vat 12 is generally rectangular in shape and includes a bottom wall 20, spaced apart vertical side walls 22, 24, and front and rear walls 26, 28.

Further referring to FIG. 1, track 18 is positioned above and extends the entire length of vat 12. Track 18 is mounted to support brackets 30, 32 at both ends of vat 12. Carriage 16 is coupled to track 18 and is movable along the entire length thereof in both directions such that knife 14 may travel the entire length of the interior of vat 12. Carriage 16 may be self-propelled or coupled to a separate motor (e.g., via a chain, belt, or gear coupling system) that supplies the power necessary to move carriage 16 along track 18.

The various components of the cheese processing system 10 may be made of a variety of materials, including metal, plastic, wood, or various composites. The terms “knife,” “carriage,” and “track” are intended to be broad terms and not terms of limitation. These components may be used with any of a variety of products and are not intended to be limited to use with particular types of cheeses.

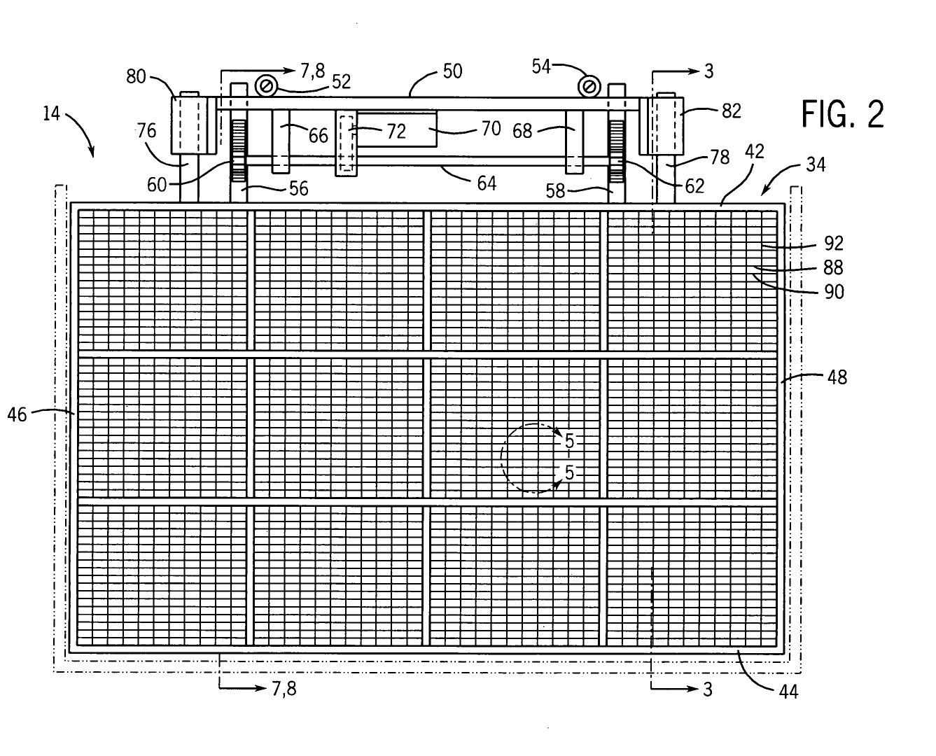

Referring to FIG. 2, knife 14 is positioned transversely within vat 12 and has a perimeter slightly smaller than the interior of the transverse cross-section of vat 12. In an exemplary embodiment, knife 14 includes a frame 34, a set of vertical cutting wires 92, and two sets of offset horizontal cutting wires 88, 90. Frame 34 includes horizontal members 42, 44 upon which vertical cutting wires 92 are strung, and vertical members 46, 48 upon which horizontal cutting wires 88, 90 are strung. Knife 14 is mounted to a reciprocating mechanism, which is in turn mounted to a horizontal support or rail 50. Two spaced apart sleeves 52, 54 couple the rail 50 to the carriage 16 such that knife 14 moves jointly with carriage 16 as it moves along track 18.

In the embodiment shown in FIG. 2, the reciprocating mechanism includes two spaced apart racks 56, 58 that are mounted to the frame 34. Racks 56, 58 are coupled to pinions 60, 62 that mount to a shaft 64 such that as shaft 64 reciprocates, the racks 56, 58 are continuously reciprocated in a vertical direction. Shaft 64 is supported by two plates 66, 68 and is driven by an independent power source 70. Power source 70 rotates a driving member 72 that is coupled to shaft 64. The continuous reciprocation avoids high rates of cutting wire movement that may increase the production of fines and reduce the ultimate yield of the cutting process.

Further referring to FIG. 2, two alignment members 76, 78 extend upwardly from frame 34 into alignment guides 80, 82 such that the vertical orientation of frame 34 is maintained during reciprocation while knife 14 travels through the coagulum. Alignment members 76, 78, being mounted to frame 34, reciprocate jointly with knife 14 and frame 34. Alignment guides 80, 82 are mounted to rail 50 and do not reciprocate vertically with knife 14.

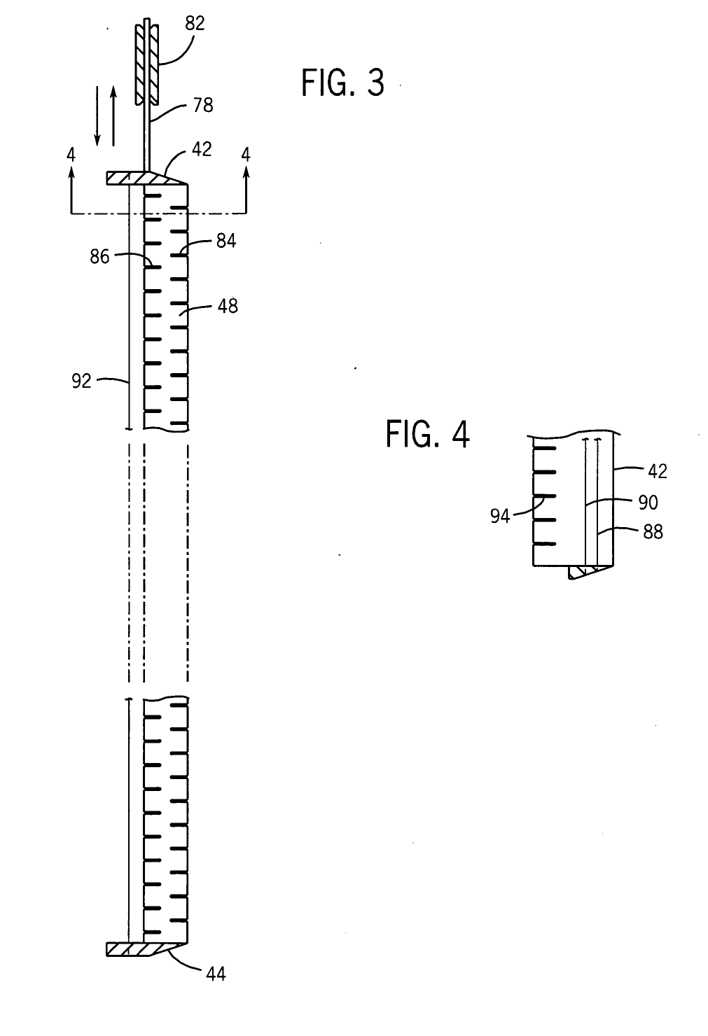

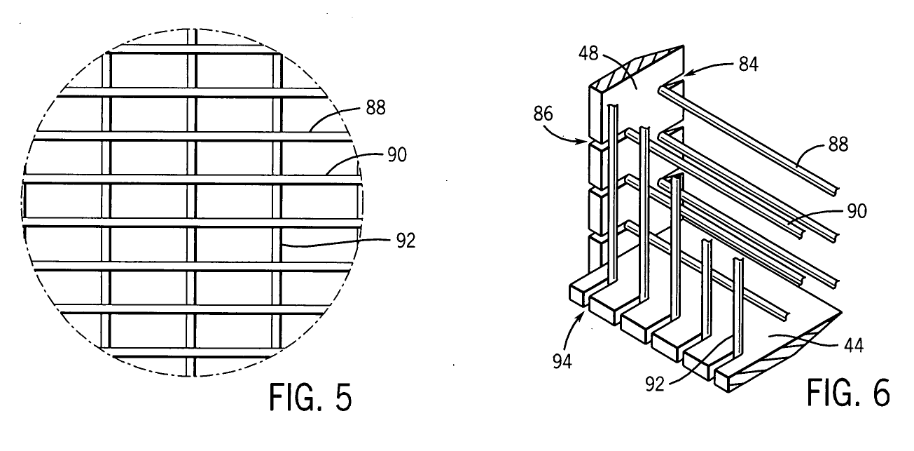

Referring to FIGS. 3, 4, 5, and 6, vertical frame member 48 includes front and rear slots 84, 86 that are configured to accept the first and second sets of horizontal cutting wires 88, 90. As shown, slots 84 and 86 are located on opposing edges of vertical member 48. Vertical member 46 (see FIG. 2) is similarly configured to vertical member 48. Front and rear slots 84, 86 are offset from each other both horizontally and vertically. As shown in FIGS. 4 and 6, horizontal frame members 42, 44 include slots 94 that are configured to accept vertical cutting wires 92.

In an exemplary embodiment, to mount horizontal wires 88, 90 to frame 34, a single length of wire is first attached at one of the top-most or bottom-most slots 84, 86 on one of the vertical frame members 46, 48. The wire is then strung across frame 34 to the corresponding slot 84, 86 on the opposing frame member 46, 48 and wrapped around the exterior of the vertical frame member 46, 48 and through the next higher or lower slot 84, 86 on the other side of the frame member 46, 48. The wire is then strung across frame 34 again, and the process repeated until all of slots 84, 86 are filled with cutting wires 88, 90. The effect of this method of stringing the wires is that the first and second sets of horizontal wires 88, 90 are strung substantially simultaneously. In the embodiment shown in FIGS. 3-6, as knife 14 is passed through the coagulum, the second set of horizontal wires 90 trails the first set of horizontal wires 88.

Vertical wires 92 are strung in a similar manner, wrapping cutting wire 92 back and forth between corresponding slots 94 on opposing horizontal frame members 42, 44. In the embodiment shown in FIGS. 3-6, vertical cutting wires 92 trail the second set of horizontal wires 90 as knife 14 is passed through the coagulum.

In an alternative embodiment, the horizontal and vertical wires 88, 90, 92 are strung using individual lengths of wire that are discreetly attached at each slot location. The wires alternatively may be held using mechanical fasteners, a tension fit, or any other conventional means.

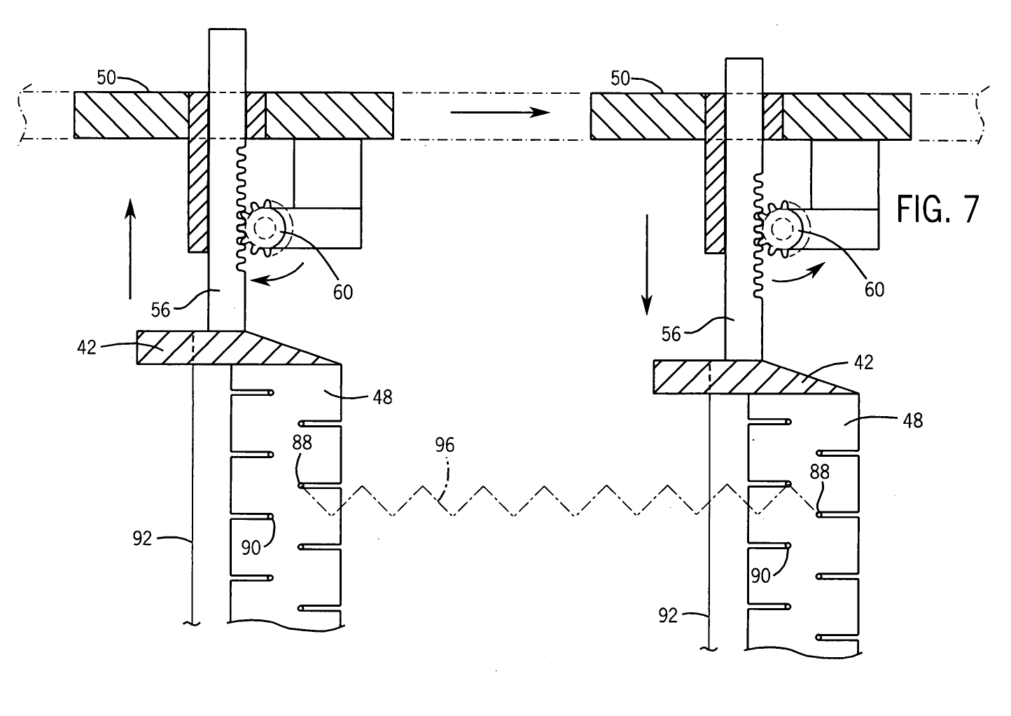

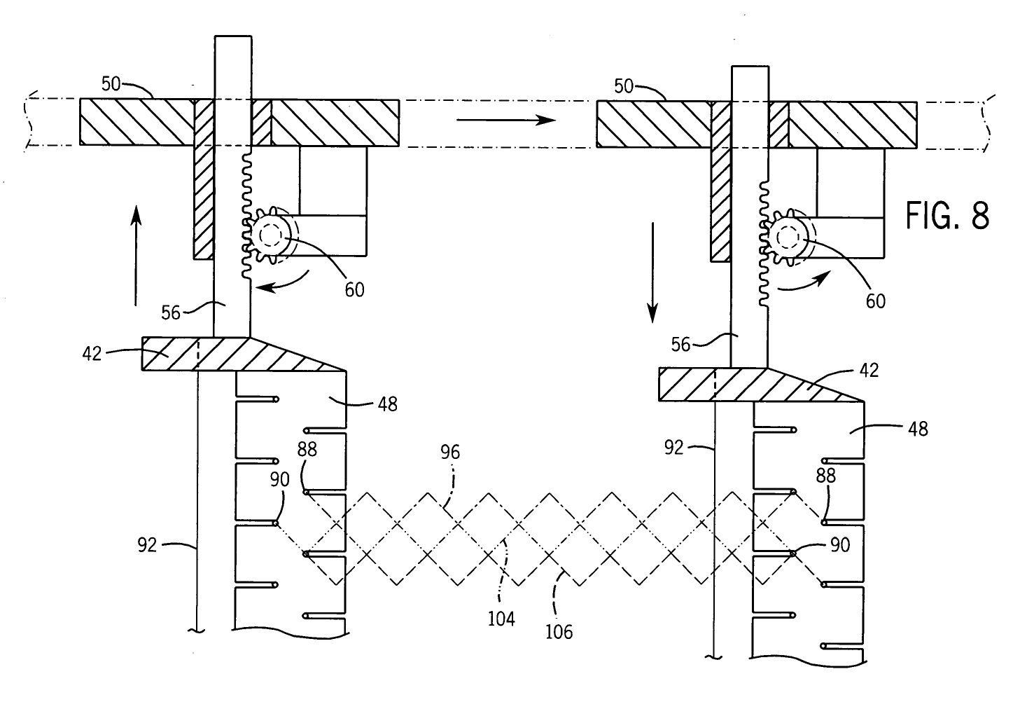

Referring to FIGS. 7 and 8, as power source 70 continuously reciprocates shaft 64, the racks 56, 58 and pinions 60, 62 cause knife 14 to continuously reciprocate up and down in a vertical direction. Thus, as knife 14 travels jointly with carriage 16 along the length of vat 12, knife 14 also independently and continuously reciprocates in a vertical direction, causing knife 14 to effectively travel at alternating upward and downward angles through the coagulum. As used herein, the term “continuously reciprocate” is intended to mean continuous reciprocating motion back and forth in a particular direction as opposed to other systems that may exhibit non-continuous reciprocating motion, such as systems that move back and forth at discrete intervals rather than exhibiting continuous motion. As shown in FIG. 7, the combination of the joint travel of knife 14 with carriage 16 and the continuous reciprocation of knife 14 causes each individual horizontal wire 88, 90 to create a saw-tooth cutting pattern 96.

Referring to FIG. 8, the first and second sets of horizontal cutting wires 88, 90 are offset from each other such that as knife 14 moves through the coagulum and each individual wire 88, 90 travels in a saw-tooth pattern, each highest point of any individual wire's cutting pattern 104 from the second set of horizontal wires 90 coincides with a lowest point of the cutting pattern 96 of the immediately higher wire of the first set of horizontal wires 88. Thus, cutting patterns 96 and 104 of cutting wire sets 88, 90 intersect at discreet points along the range of travel of knife 14. As illustrated by cutting pattern 106, additional wires create similar intersecting patterns. The intersection of the various cutting wires 88, 90 creates the aggregate cutting pattern illustrated by patterns 96, 104, 106 in FIG. 8. The relative speeds of the horizontal movement of knife 14 due to the motion of carriage 16 and the reciprocating motion of knife 14 are monitored and adjusted appropriately to maintain the proper cutting patterns during the cutting process.

Note that the orientation of the knife may differ relative to the vat and coagulum and still accomplish the single stage cutting into cubes. In the embodiment described above, the knife travels in a first, horizontal direction along the vat and reciprocates in a second, vertical direction, but the second direction may be in a transverse direction, still or the orthogonal to the first direction and still accomplish the single stage cutting process.

In an exemplary embodiment (not shown), both the motor supplying the force to move carriage 16 and the motor supplying the force to reciprocate knife 14 are electronically connected to a monitoring circuit that assures the proper rate of travel of knife 14 in both the horizontal and vertical directions. The monitoring circuit continuously makes any necessary adjustments to the speeds of the motors in order to maintain the proper cutting pattern.

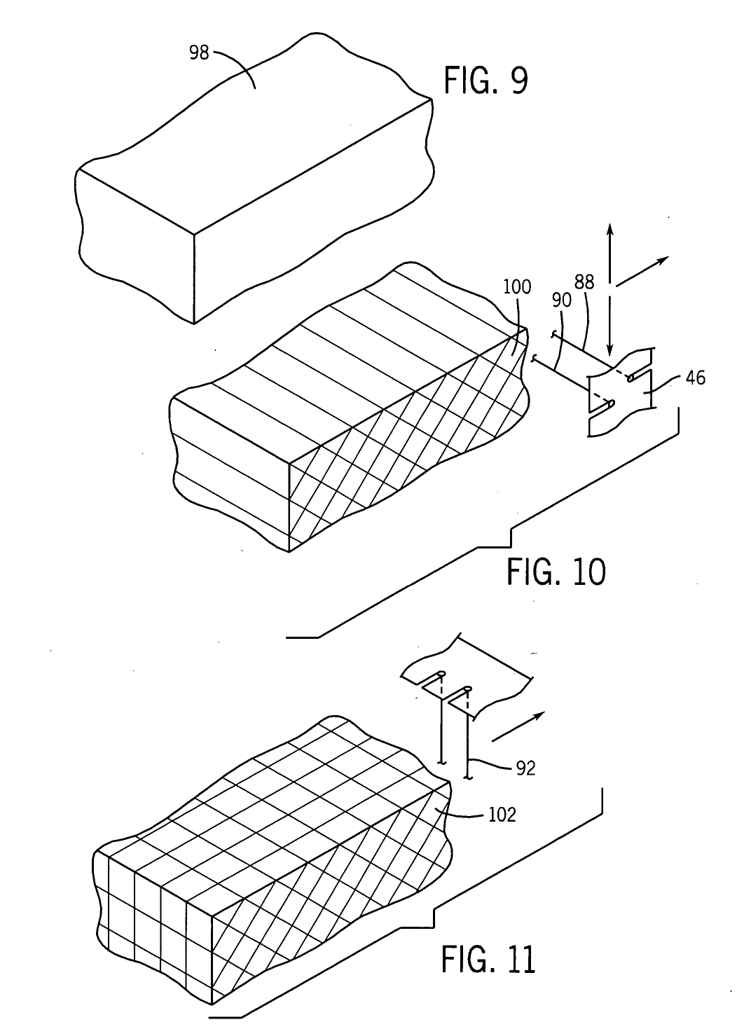

Referring to FIGS. 9, 10, and 11, the uncut coagulum 98 is a generally homogeneous semi-solid mass, as shown in FIG. 9. As shown in FIG. 10, as the two sets of horizontal wires 88, 90 pass through coagulum 98, transverse columns 100 are formed by the saw-tooth cutting motion of the horizontal cutting wires 88, 90. FIG. 11 shows the cubical portions 102 that remain after vertical wires 92 are passed though coagulum 98, dividing the transverse columns 100 into generally cube-shaped pieces 102. After a single pass of knife 14, coagulum 98 will have been cut into cubical pieces 102, the size of each cube 102 being determined by the spacing between cutting wires 88, 90, 92.

In operation, during the cheese making process, vat 12 contains a coagulum of curd to be cut into cubes 102. To do so, knife 14 is attached to carriage 16, located at one end of vat 12, such that horizontal wires 88, 90 will lead vertical wires 92 as knife 14 is moved through vat 12. Carriage 16 is then moved along track 18 the entire length of vat 12, thereby moving the knife through the entire coagulum. Simultaneously, knife 14 is continuously reciprocated by power source 70 such that as knife 14 passes through the coagulum, individual cubes 102 are formed after only a single pass of knife 14. After carriage 16 reaches the end of vat 12, knife 14 may be removed from carriage 16 so that it may be equipped with other processing equipment, if required.

In cutting the coagulum in a single pass, much of the time and labor previously associated with traditional cheese processing systems is eliminated. No additional transverse cuts are required to complete the cutting process. Additionally, knife 14 is continuously and smoothly reciprocated as it moves through the coagulum, minimizing the production of fines, and avoiding much of the undesirable tearing and breaking of the coagulum that occurs when the knife is moved more rapidly at discreet intervals. The smooth cutting action assists in maximizing the yield of the cheese making process.

The cheese processing system 10 of the present invention and the associated method of cutting the coagulum are applicable to the processing of various types of cheeses, including, for example, stilton, cheddar, and cottage cheeses. While the exact processing method for different types of cheeses varies, a number of cheeses, including those mentioned, require cutting a coagulum at some point in the process. The advantages obtained though the use of the present invention are thus applicable to a wide range of cheese products and processing methods.

While the detailed drawings and specific examples given herein describe various exemplary embodiments, they serve the purpose of illustration only. It is to be understood that the invention is not limited in its application to the details of construction and the arrangements of components set forth in the preceding description or illustrated in the drawings. For example, the knife could be reciprocated in a horizontal, rather than vertical direction, and the orientation of the cutting wires modified accordingly. Further, the reciprocating mechanism is shown in one embodiment as including a rack and pinion system attached to the frame, but may consist of other components or devices that provide the proper continuous reciprocating action for the knife. Furthermore, other substitutions, modifications, changes, and omissions may be made in the design, operating conditions, and arrangements of the exemplary embodiments without departing from the scope of the invention as expressed in the appended claims.

What is claimed is:

1. A cheese processing system, comprising:
a vat;
a knife extending into the vat; and
a drive mechanism configured to move the knife in a horizontal direction through the vat;
wherein the knife continuously reciprocates in a vertical direction as the knife moves in the horizontal direction through the vat.

2. The system of claim 1, wherein the drive mechanism comprises a carriage supported by a track.

3. The system of claim 2, wherein the carriage is movably coupled to the track such that the carriage is movable along a length of the vat in the horizontal direction.

4. The system of claim 3, wherein the knife is removably coupled to the carriage.

5. The system of claim 4, wherein the track is mounted above the vat and extends the length of the vat.

6. A cheese processing system, comprising:
avat;
a knife extending into the vat; and
a drive mechanism configured to move the knife in a first direction through the vat;
wherein the knife continuously reciprocates in a second direction orthogonal to the first direction as the knife moves in the first direction through the vat.

7. The system of claim 6, wherein the drive mechanism comprises a carriage supported by a track.

8. The system of claim 7, wherein the carriage is movably coupled to the track such that it is movable along the vat in the first direction.

9. The system of claim 8, wherein the knife is removably coupled to the carriage.

10. The system of claim 9, wherein the track is mounted above the vat.

11. The system of claim 6, wherein the first direction is in a longitudinal direction along a length of the vat.

12. The system of claim 11, wherein the second direction is in a transverse direction across a width of the vat.

13. The system of claim 11, wherein the second direction is in a vertical direction.

14. A cheese processing system, comprising:
a vat;
a knife extending into the vat;
a drive mechanism for moving the knife in a first direction through the vat; and
a means for continuously reciprocating the knife in a second direction orthogonal to the first direction as the knife moves though the vat in the first direction.

15. The system of claim 14, wherein the drive mechanism comprises a carriage supported by a track.

16. The system of claim 15, wherein the carriage is movably coupled to the track such that the carriage is movable along the vat in the first direction.

17. The system of claim 14, wherein the means of continuously reciprocating the knife in the second direction comprises:
a power source coupled to a pinion; and
a rack coupled to the knife and the pinion;
wherein the power source continuously reciprocates the pinion, causing the rack and the knife to continuously reciprocate.

18. A method for processing cheese, comprising:
providing a vat;
providing a knife extending into the vat, wherein the knife comprises a plurality of cutting wires;
moving the knife through the vat in a first direction; and
continuously reciprocating the knife in a second direction orthogonal to the first direction as the knife moves through the vat in the first direction.

19. The method of claim 18, wherein the plurality of cutting wires comprises:
a plurality of parallel and coplanar first cutting wires;
a plurality of parallel and coplanar second cutting wires;
wherein the plurality of first cutting wires are offset along the first direction from the plurality of second cutting wires; and
wherein a distance between any two adjacent cutting wires of the plurality of first cutting wires equals a distance between any two adjacent cutting wires of the plurality of second cutting wires.

20. The method of claim 19, wherein a distance of reciprocation equals the distance between any two adjacent cutting wires of the plurality of first cutting wires.

21. The method of claim 20, wherein the second direction is a vertical direction.

22. The method of claim 21, further comprising removing the knife assembly from the carriage.

23. A knife for cutting curd, comprising:
a frame having at least one straight portion;
a plurality of first cutting wires mounted to the frame, wherein the plurality of first cutting wires are parallel to each other and the straight portion; and
a plurality of second cutting wires mounted to the frame, wherein the plurality of second cutting wires are parallel to each other and the straight portion;
wherein a first plane defined by the plurality of first cutting wires is parallel to and spaced apart from a second plane defined by the plurality of second cutting wires.

24. The knife of claim 23, further comprising a plurality of third cutting wires mounted to the frame, wherein the plurality of third cutting wires are parallel to each other and perpendicular to the straight portion.

25. The knife of claim 24, wherein a first distance defined by the distance between any two adjacent first cutting wires is equal to a second distance defined by the distance between any two adjacent second cutting wires.

26. The knife of claim 25, wherein a third distance defined by the distance between the first plane and the second plane is equal to the one-half of the first distance.
